(19) United States
(12) Patent Application Publication
(10) Pub. No.: US 2004/0249560 A1
(43) Pub. Date: Dec. 9, 2004

(54) Method and apparatus for collecting traffic data in real time

(75) Inventors: Byung-Wook Kim, Seoul (KR); Jin-Won Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., KYUNGKI-DO (KR)

(21) Appl. No.: 10/637,877

(22) Filed: Aug. 8, 2003

(30) Foreign Application Priority Data
Jun. 4, 2003 (KR) 35966/2003

(51) Int. Cl. G06G 7/76

(52) U.S. Cl. 701/117; 340/907

(57) ABSTRACT

A method and apparatus for collecting traffic data in real time are disclosed. When a mobile terminal having received real time traffic data generates a position registration message including the real time traffic data, and then transmits the generated position registration message, a regional traffic server, which manages regional traffic information within a predetermined area, receives the position registration message, and extracts the traffic data from the position registration message. Further, the regional traffic server stores the extracted traffic data in a regional traffic information management database, and then transmits regional traffic information to a central traffic server, thereby enabling the central traffic server to synthetically manage national traffic information. Because messages transmitted/received when a mobile terminal of a mobile communication system, which has been already installed and spread, registers its position, are utilized, the initial investment cost and maintenance cost for collecting traffic data in real time are minimized. Further, because traffic data of corresponding positions from an unspecified plurality of mobile terminals cooperating with a navigation terminal are collected, traffic data can be collected more accurately in real time.

### PRIORITY

This application claims priority to an application entitled “Method and Apparatus for Collecting Traffic Data in Real Time” filed in the Korean Industrial Property Office on Jun. 4, 2003 and assigned Serial No. 2003-35966, the contents of which are hereby incorporated by reference.

### BACKGROUND OF THE INVENTION

1. Field of the Invention

The present invention relates generally to a method and apparatus for collecting traffic data in real time, and more particularly to a method and apparatus for collecting traffic data in real time by means of a message, such as a position registration message, transmitted/received when a mobile terminal registers its position.

2. Description of the Related Art

Conventionally, movable bodies, such as ships, airplanes and vehicles, are provided with navigation systems for determining positions of the movable bodies and providing an optimal path to a destination. These navigation systems determine the positions of the movable bodies by means of a GPS (Global Positioning System) position measuring device. GPS implies a system for tracing a global location by means of 24 artificial satellites orbiting at a height of about 20,183 km. The GPS position measuring device receives radio signals, which represent a latitude, a longitude and an altitude, etc., from a plurality of satellites included in the GPS, and it calculates current positions of the movable bodies. Further, the GPS position measuring device displays geographical information including the current positions on the basis of map data stored in advance. That is, a conventional navigation system provides drivers with various information necessary for traveling, by means of information received from the GPS. For example, the navigation system displays a current speed of movement, a path of movement set by a driver before traveling, and an optimal path to a destination.

Core technologies of navigation systems include a positioning technology for accurately positioning a vehicle and routing technology for determining a path to a destination. More particularly, the navigation system utilizes real time traffic data to provide drivers with an optimal path to a destination.

In the prior art, real time traffic data is collected by an image detector, a traffic volume detection sensor, such as a beacon, and a loop detector. However, according to the prior method, an enormous investment cost and continuous system upgrades are necessary. In addition, there are many technical problems.

In collecting traffic data by means of the image detector, images of vehicles traveling on a road are collected by video cameras and then necessary traffic data, such as traffic volume, speed, and vehicle length, are obtained by analyzing and processing the collected images. However, according to this method, environment settings must be changed according to installation areas of video cameras, and measurement errors may occur due to weather. Further, because the video cameras may not operate owing to particles, pollutants, and rain, etc., frequent maintenance is necessary.

When collecting traffic data by means of the traffic volume detection sensors such as beacons, a traffic data collection vehicle receives signals of the traffic volume detection sensors installed on important crossroads while traveling on a road, and stores the received signals. Then, the traffic data collection vehicle transmits the stored signals to a traffic data center through a wireless base station device. In this way, traffic data is collected in real time. However, according to this method, the traffic volume detection sensors must be installed in all places where traffic data must be collected.

Additionally, when collecting traffic data by means of the loop detector, two loop coil sensors are buried under a road surface of each lane of an express highway and the two loop coil sensors are connected to the loop detector. Then, the loop detector detects minute changes in the loop coil inductance caused by vehicles passing on the loop coil sensors and amplifies the changes, thereby detecting existence and speed of vehicles currently passing on the loop coil sensors. However, in this method also, loop coil sensors must be installed in all places where the traffic data is collected. Moreover, it is difficult to bury the loop coil sensors under a road surface.

As described above, in the conventional real time traffic data collection method, in order to collect traffic data, new equipment must be installed in every location from which information is desired. Further, an initial investment cost and continuous maintenance costs for the equipment are expensive.

### SUMMARY OF THE INVENTION

Accordingly, the present invention has been designed to solve the above and other problems occurring in the prior art, and a first object of the present invention is to provide a method and apparatus for collecting traffic data in real time, which minimizes an initial investment cost and maintenance costs.

It is a second object of the present invention to provide a method and apparatus for collecting traffic data in real time, utilizing an apparatus, which has already been installed and spread, without a separate apparatus.

It is a third object of the present invention to provide a method and apparatus for collecting traffic data in real time by means of a mobile communication system.

It is a fourth object of the present invention to provide a method and apparatus for collecting traffic data in real time by means of a message, such as a position registration message, transmitted/received when a mobile terminal registers its position.

In order to accomplish the above and other objects, according to a preferred embodiment of the present invention, there is provided a method for collecting traffic data in real time, the method comprising the steps of: (1) generating/transmitting a position registration message including real time traffic data in a mobile terminal having received the real time traffic data from a navigation terminal; (2) managing regional traffic information within a predetermined area by a regional traffic server, and receiving the position registration message; and (3) extracting traffic data from the position registration message, and storing the extracted traffic data in a regional traffic information management database.

Additionally, there is provided a mobile terminal for transmitting traffic data in real time, the mobile terminal comprising: a navigation terminal interface unit for receiving real time traffic data from a navigation terminal that is installed on a mobile body and reads traveling information of the mobile body; a mobile phone function processing unit for controlling mobile phone functions of the mobile terminal, and transmitting a position registration message to a BSC after determining whether a position of the mobile terminal is registered; and a format processing unit for receiving the traffic data from the navigation terminal interface unit, temporarily storing it, generating the position registration message including the stored traffic data when a position registration is determined by the mobile phone function processing unit, and transmitting the generated position registration message to the mobile phone function processing unit.

Further, there is provided a regional traffic information management apparatus comprising: a position registration message analyzing unit for receiving a position registration message from a BSC, analyzing the position registration message, and then determining whether traffic data have been included in the position registration message; a traffic data extraction unit for extracting the traffic data from the position registration message when the traffic data has been included in the position registration message; a traffic data decoding unit for decoding the traffic data extracted by the traffic data extraction unit; and a regional traffic information storage unit for storing the traffic data determined by the traffic data decoding unit as being regional traffic information.

### BRIEF DESCRIPTION OF THE DRAWINGS

The above and other objects, features, and advantages of the present invention will be more apparent from the following detailed description taken in conjunction with the accompanying drawings, in which:

FIG. 1 illustrates an apparatus for collecting traffic data in real time by means of a mobile communication system;

FIG. 2 illustrates a method for collecting traffic data in real time according to an embodiment of the present invention;

FIG. 3 illustrates a data format of a position registration message that is transmitted by a mobile terminal according to an embodiment of the present invention;

FIG. 4 is a block diagram illustrating a mobile terminal for transmitting traffic data in real time according to an embodiment of the present invention;

FIG. 5 is a flowchart illustrating a method in which a mobile terminal transmits traffic data in real time according to an embodiment of the present invention;

FIG. 6 is a block diagram illustrating a BSC-based traffic server, which receives real time traffic data from a mobile terminal, and then processes it according to an embodiment of the present invention;

FIG. 7 is a flowchart illustrating a method by which a BSC-based traffic server processes traffic data in real time according to an embodiment of the present invention;

FIG. 8 is a flowchart illustrating a process method of a central traffic server according to an embodiment of the present invention; and

FIG. 9a to FIG. 9e illustrate traffic data collected in areas according to an embodiment of the present invention.

### DETAILED DESCRIPTION OF THE PREFERRED EMBODIMENT

Preferred embodiments of the present invention will be described in detail herein below with reference to the accompanying drawings. In the following description of the present invention, a detailed description of known functions and configurations incorporated herein will be omitted when it may make the subject matter of the present invention rather unclear.

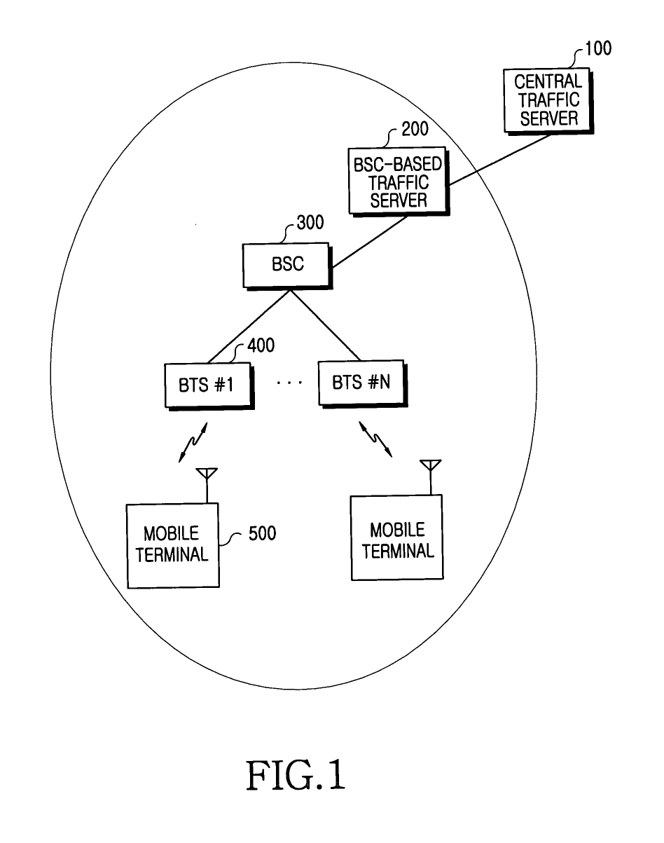

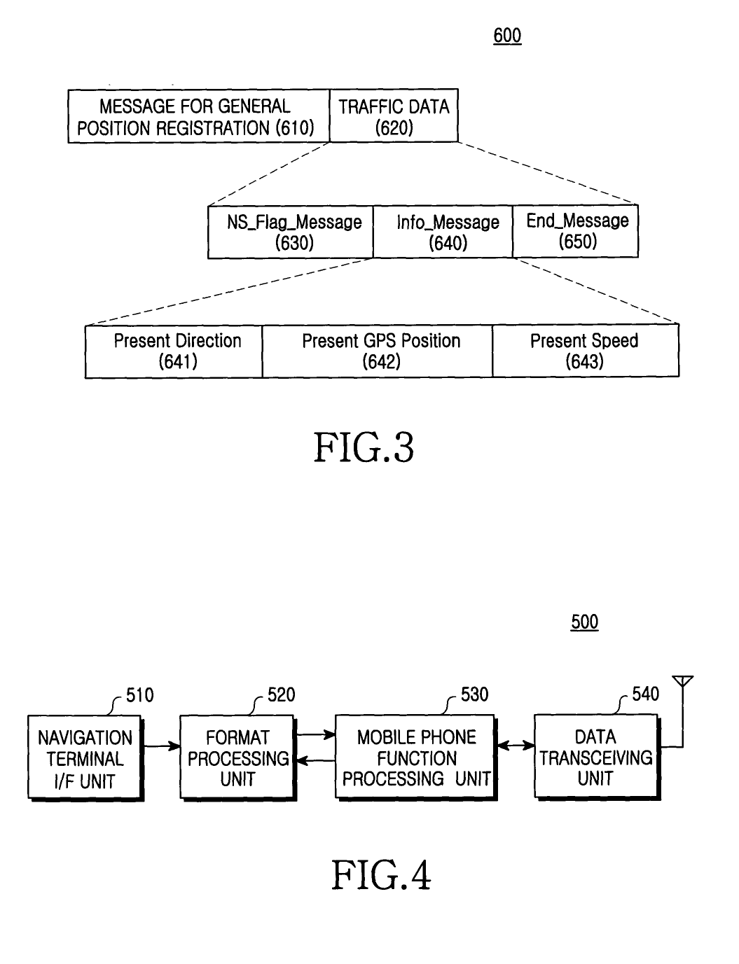

FIG. 1 illustrates an apparatus for collecting traffic data in real time by means of a mobile communication system. Referring to FIG. 1, the apparatus for collecting traffic data in real time utilizing a mobile communication system includes a mobile terminal 500, BTSs (base transceiver stations, BTS #1 to BTS #N) 400, a BSC (base station controller) 300, a BSC-based traffic server 200, and a central traffic server 100. The mobile terminal 500 transmits traffic data regarding a position of the mobile terminal 500 to the BSC-based traffic server 200 via the BTS 400 and the BSC 300. In a typical mobile communication system, for position movement, etc., the mobile terminal 500 registers its position to a district base station in an area in which the mobile terminal 500 is located. According to the present invention, the mobile terminal 500 adds the traffic data to a message, such as a position registration message, transmitted when the mobile terminal 500 registers its position, and then transmits the position registration message to the BSC-based traffic server 200 via the BTS 400 and the BSC 300. An example showing the structure of the position registration message including the traffic data according to the present invention will be described below with reference to FIG. 3.

The BSC-based traffic server 200 generates regional traffic information from the traffic data transmitted from the mobile terminal 500, and then transmits the regional traffic information to the central traffic server 100. The central traffic server 100 collects the regional traffic information transmitted from each BSC-based traffic server 200, and then generates/manages national traffic information.

Also, when traffic information is requested from the mobile terminal 500, the central traffic server 100 transmits corresponding traffic information to a corresponding mobile terminal via the BSC-based traffic server 200, the BSC 300, and the BTS 400 to which the mobile terminal 500 belongs. Because the present invention relates to a method and apparatus for collecting traffic data in real time, a method for providing traffic data will not be described in detail.

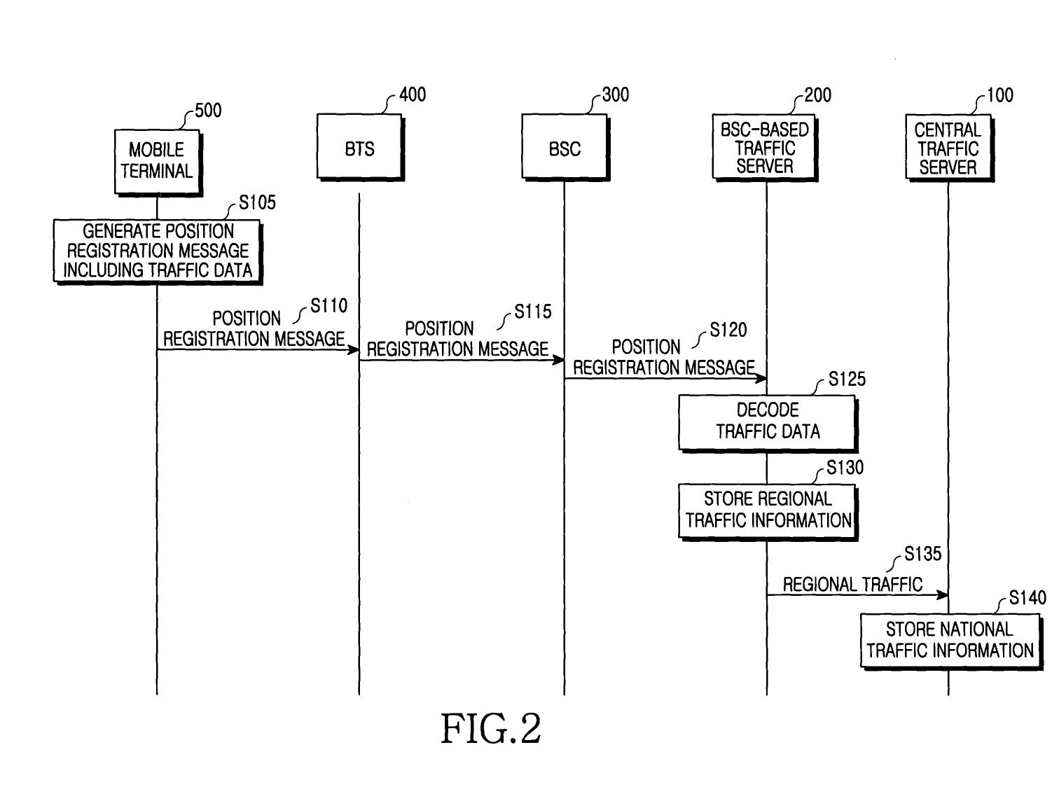

FIG. 2 is a flowchart illustrating a method for collecting traffic data in real time according to an embodiment of the present invention. Referring to FIG. 2, when the mobile terminal 500 satisfies a position registration condition, the mobile terminal 500 generates a position registration message including traffic data (S105), and then transmits the position registration message to the BSC-based traffic server 200 via the BTS 400 and the BSC 300 (S110, S115, S120).

As illustrated in FIG. 3, the position registration message 600 generated in step 105 includes a message 610 for a general position registration and traffic data 620. The traffic data 620 includes a navigation station flag (NS_Flag_Message) 630, an actual traffic data (Info_Message) 640, and an end message (End_Message) 650. The navigation station flag (NS_Flag_Message) 630 and the end message (End_Message) 650 are identification information for informing a start and an end of the traffic data, and an actual traffic data transmitted upward is data stored in the actual traffic data 640. The actual traffic data (Info_Message) 640 includes a moving direction (present direction) 641, a present position (present GPS position) 642 and a moving speed (present speed) 643. It is preferred that the present position 642 is a link number including a position of a mobile terminal on digital map data.

Also, in order to generate the position registration message 600 including the traffic data 620, the mobile terminal 500 must know a moving direction, present position, and moving speed of a mobile terminal. However, in a conventional navigation system, the information, such as a moving direction, a present position, and a moving speed, are received from a navigation terminal installed on a movable body, and a present position of the mobile terminal 500 is transmitted to a navigation server. However, in order to generate the position registration message 600 including the traffic data 620, the mobile terminal 500 of the present invention utilizes the information, such as a moving direction, a present position, and a moving speed, transmitted from the navigation terminal.

Referring to FIG. 2 and FIG. 3, the BSC-based traffic server 200 having received the position registration message 600 in step S120 analyzes the traffic data included in the position registration message 600 to decode it (S125). Further, as a result of the decoding (S125), the BSC-based traffic server 200 receives a moving speed and a moving direction of the mobile terminal 500 at present position of the mobile terminal 500, and then stores the information as regional traffic information (S130). Further, the BSC-based traffic server 200 transmits the regional traffic information to the central traffic server 100 (S135), thereby enabling the central traffic server 100 to store/manage national traffic information integrating each regional traffic information (S140).

FIG. 4 is a block diagram illustrating the mobile terminal 500 that transmits traffic data in real time according to an embodiment of the present invention. Referring to FIG. 4, the mobile terminal 500 according to an embodiment of the present invention includes a navigation terminal I/F unit 510, a format processing unit 520, a mobile phone function processing unit 530 and a data transceiving unit 540. The navigation terminal I/F unit 510 receives real time traffic data, such as a present position, a moving direction and a moving speed, from a navigation terminal. Herein, the navigation terminal is installed on a movable body and reads traveling information of the movable body. The format processing unit 520 receives the traffic data from the navigation terminal I/F unit 510, and then temporarily stores it. When a position registration order is transmitted from the mobile phone function processing unit 530, the format processing unit 520 generates a position registration message including the traffic data, and then transmits the generated position registration message to the mobile phone function processing unit 530. The mobile phone function processing unit 530 performs mobile phone functions, which are general functions of the mobile terminal 500. Further, when a position of the mobile terminal 500 must be registered, the mobile phone function processing unit 530 outputs the position registration order to the format processing unit 520, and then transmits the position registration message transmitted from the format processing unit 520 in response to the output, particularly, the position registration message including the traffic data, to the data transceiving unit 540. The data transceiving unit 540 transmits/receives various data for performing mobile phone functions, and particularly transmits the position registration message including the traffic data received from the mobile phone function processing unit 530. Further, the data transceiving unit 540 is capable of extracting only the traffic data from the position registration message to transmit it.

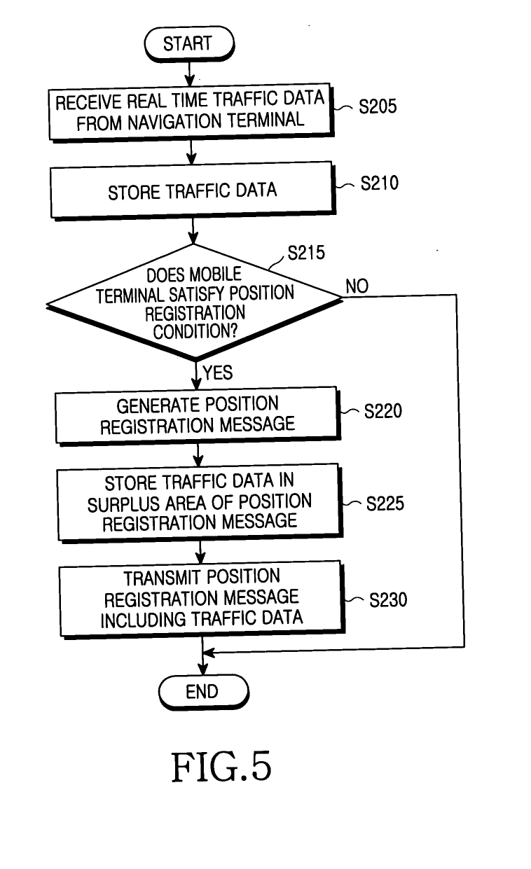

FIG. 5 is a flowchart illustrating a method in which a mobile terminal transmits traffic data in real time according to an embodiment of the present invention. Referring to FIG. 5, the navigation terminal I/F unit 510 receives real time traffic data from the navigation terminal (S205), and then transmits the traffic data to the format processing unit 520. Then, the format processing unit 520 temporarily stores the traffic data (S210). Also, the mobile phone function processing unit 530 determines whether the mobile terminal 500 satisfies position registration conditions (S215). When the mobile terminal 500 meets position registration conditions, the mobile phone function processing unit 530 transmits a position registration order to the format processing unit 520.

In this case, the position registration conditions of the mobile terminal 500 include nine typical cases as follows:

\mathring{1} when power of a mobile station is turned on, and a predetermined time, e.g., twenty seconds, passes;

\mathring{2} when the power of the mobile station is turned off;

\mathring{3} in each predetermined period set by a paging channel (system parameter message);

\mathring{4} whenever the mobile station moves a predetermined distance, e.g., when the mobile station is spaced more than a predetermined distance from a base station at which the mobile station has registered its last position by means of latitude and longitude data of a base station included in the system parameter message;

\mathring{5} when the mobile station moves new zone;

\mathring{6} when a user artificially changes a state of the mobile station;

\mathring{7} due to a compulsive instruction of a base station;

\mathring{8} when a user gives a call or receives a call; and

\mathring{9} when the base station to which the mobile station belongs changes due to a hand-off.

Accordingly, when the mobile terminal 500 satisfies more than one condition from among the nine conditions, the mobile phone function processing unit 530 transmits the position registration order to the format processing unit 520. Then, the format processing unit 520 generates a general position registration message (S220), and then stores the traffic data in surplus area of the position registration message (S225). That is, the format processing unit 520 generates the position registration message including the traffic data, and then transmits the position registration message including the traffic data via the mobile phone function processing unit 530 and the data transceiving unit 540 (S230).

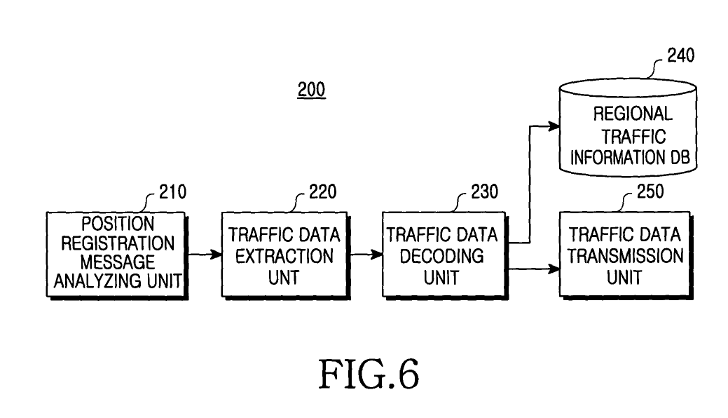

FIG. 6 is a block diagram illustrating the BSC-based traffic server 200 that receives real time traffic data from the mobile terminal 500, and then processes it according to an embodiment of the present invention. Referring to FIG. 6, the BSC-based traffic server 200 according to an embodiment of the present invention includes a position registration message analyzing unit 210, a traffic data extraction unit 220, a traffic data decoding unit 230, a regional traffic information database (DB) 240, and a traffic data transmission unit 250.

When a position registration message is received from the mobile terminal 500, the position registration message analyzing unit 210 analyzes the position registration message, and then determines whether traffic data have been included in the position registration message. From the analysis result of the position registration message analyzing unit 210, when the traffic data have been included in the position registration message received from the mobile terminal 500, the traffic data extraction unit 220 extracts the traffic data from the position registration message. The traffic data decoding unit 230 decodes the traffic data extracted by the traffic data extraction unit 220, and then determines a present position, moving direction, and moving speed of the mobile terminal 500.

The present position, moving direction and moving speed of the mobile terminal 500 received by the traffic data decoding unit 230 are stored in the regional traffic information DB 240 as regional traffic information. The information is managed by the regional traffic information DB 240 according to the link. For example, the information is classified into moving speeds and moving directions according to links, and then stored in the regional traffic information DB 240. Further, it is preferred that, in order to secure the reliability of the traffic data, the traffic data and the generation time or storage time of the traffic data are managed together, and traffic data which have passed a predetermined effective time is discarded in the regional traffic information DB 240.

The traffic data transmission unit 250 transmits the regional traffic information to the central traffic server 100 so that the central traffic server 100 can synthetically manage national traffic information. Also, when the mobile terminal 500 separates traffic data from the position registration message, and then transmits only the traffic data to the BSC-based traffic server 200, the position registration message analyzing unit 210 and the traffic data extraction unit 220 transmit the traffic data to the traffic data decoding unit 230 without processing the traffic data received from the mobile terminal 500.

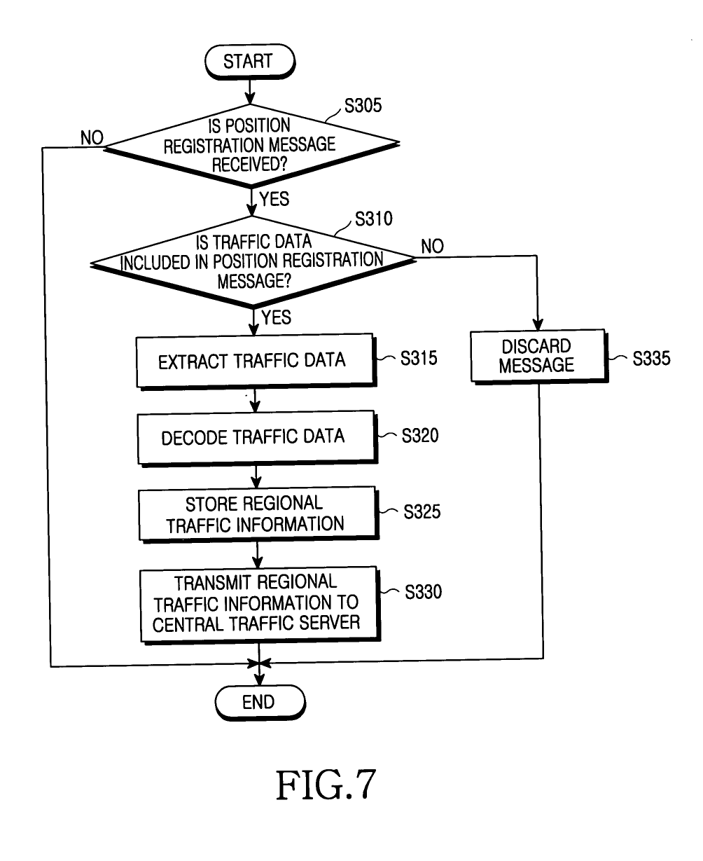

FIG. 7 is a flowchart illustrating a method by which a BSC-based traffic server processes traffic data in real time according to an embodiment of the present invention. Referring to FIG. 7, when the position registration message is received from the mobile terminal 500 (S305), the position registration message analyzing unit 210 analyzes the position registration message, and then determines whether traffic data has been included in the position registration message (S310). When the traffic data has not been included in the position registration message received from the mobile terminal 500, the message is discarded (S335). When the traffic data has been included in the position registration message received from the mobile terminal 500, the traffic data extraction unit 220 extracts the traffic data from the position registration message (S315). The traffic data decoding unit 230 decodes the traffic data extracted in step S315, and then recognizes a present position, moving direction and moving speed of the mobile terminal 500 (S320).

The present position, moving direction and moving speed of the mobile terminal 500 determined in step S320 are stored in the regional traffic information DB 240 as regional traffic information (S325). The traffic data transmission unit 250 transmits the regional traffic information to the central traffic server 100 so that the central traffic server 100 can synthetically manage national traffic information (S330).

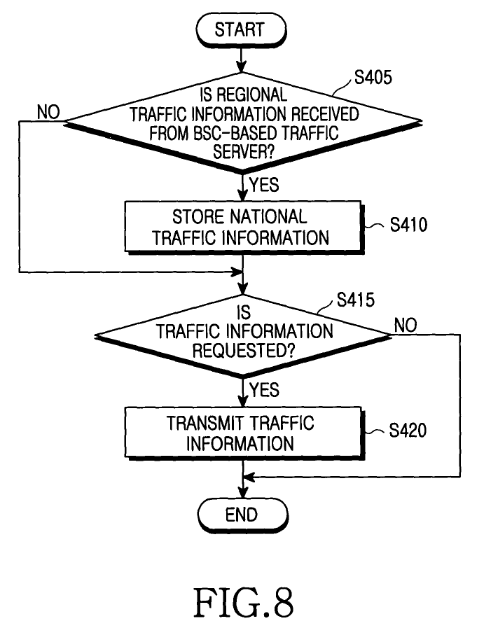

FIG. 8 is a flowchart illustrating a process method of the central traffic server 100 according to an embodiment of the present invention. Referring to FIG. 8, when the regional traffic information is received from the BSC-based traffic server 200 (S405), the central traffic server 100 stores the national traffic information by means of the regional traffic information (S410). That is, the central traffic server 100 synthesizes the regional traffic information received from a plurality of BSC-based traffic server, and then manages the synthesized information as national traffic information.

Herein, the central traffic server 100 manages the national traffic information according to the link. For example, the national traffic information is classified into moving speeds and moving directions according to links, and then is stored. That is, the central traffic server 100 manages the national traffic information in the same way as the regional traffic information DB 240 manages the regional traffic information. For instance, it is preferred that, in order to secure the reliability of the traffic data, the central traffic server 100 manages the traffic data and the generation time or storage time of the traffic data, and discards traffic data which have passed a predetermined effective time. Further, when traffic information is requested from a random mobile terminal 500 (S415), the central traffic server 100 transmits corresponding traffic information to a corresponding mobile terminal via the BSC-based traffic server 200, the BSC 300, and the BTS 400 to which the mobile terminal 500 belongs (S420). Because the present invention relates to a method and apparatus for collecting traffic data in real time, a method for providing traffic data will not be described herein.

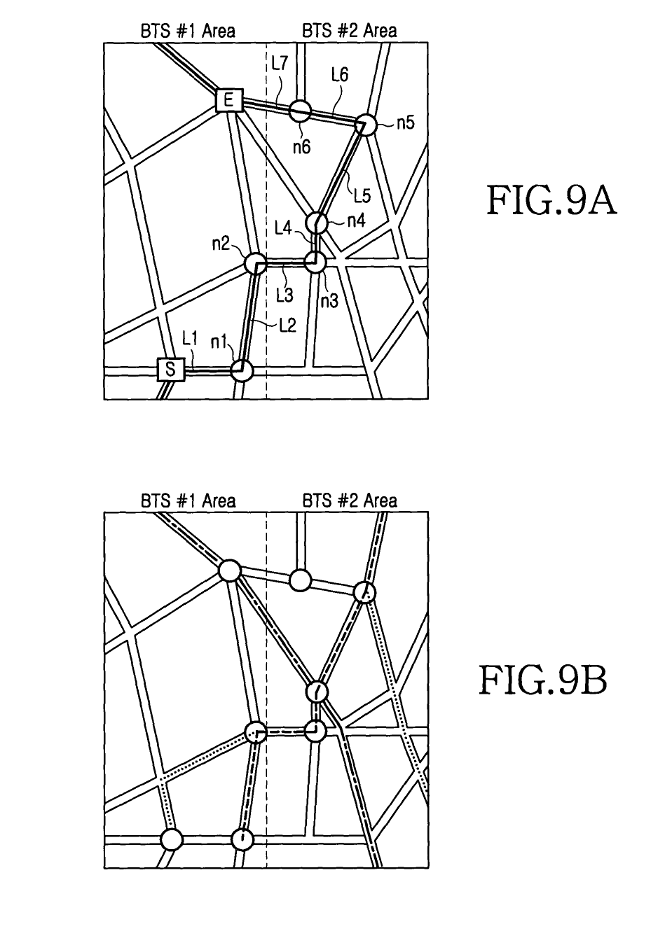

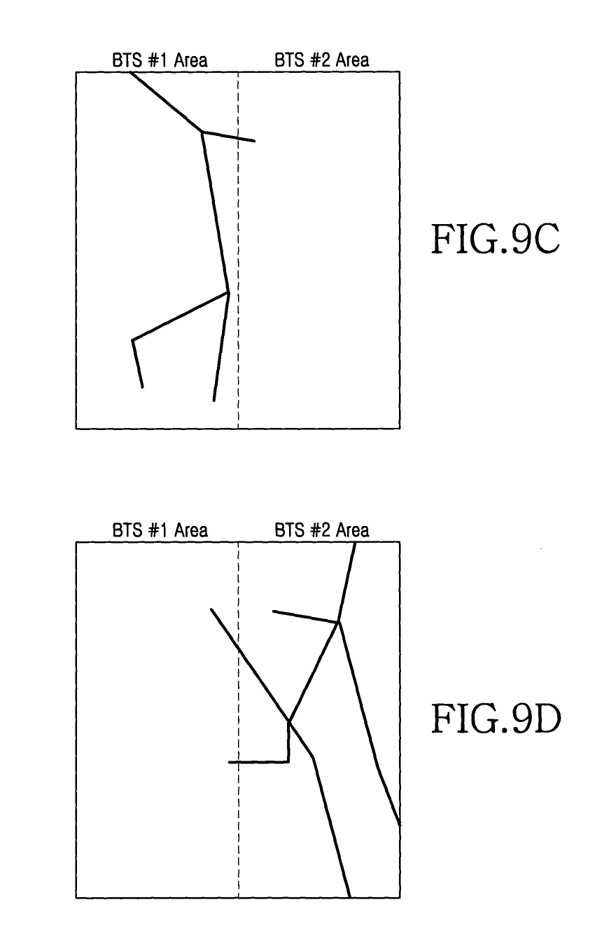

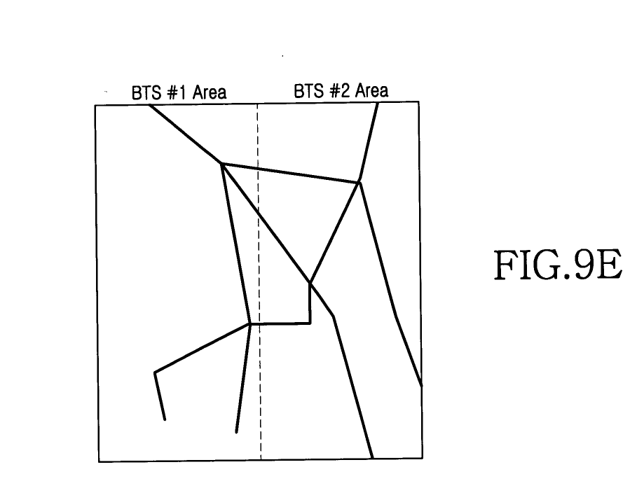

FIG. 9a to FIG. 9e illustrate a method for collecting the traffic data according to an embodiment of the present invention. Referring to FIG. 9a, when a vehicle travels from a starting point S to a destination E, the vehicle passes through a plurality of links L1 to L7 and a plurality of nodes n1 to n6. Herein, the vehicle passes through an area, which is controlled by BTS#1 (Hereinafter, referred to BTS#1 area), and an area, which is controlled by BTS#2 (Hereinafter, referred to BTS#2 area). Accordingly, when a mobile terminal, which is provided at the vehicle or which is carried with a driver of the vehicle, satisfies the following nine position registration conditions described according to a traveling of corresponding vehicle, the mobile terminal must register its position to the BTS#1 or BTS#2.

The nine position registration conditions are as follows:

\mathring{1} when power of a mobile station is turned on, and a predetermined time, e.g., twenty seconds, passes;

\mathring{2} when the power of the mobile station is turned off;

\mathring{3} in each predetermined period set by a paging channel (system parameter message);

\mathring{4} whenever the mobile station moves a predetermined distance, e.g., for instance, when the mobile station is spaced more than a predetermined distance from a base station at which the mobile station has registered its last position by means of latitude and longitude data of a base station included in the system parameter message;

\mathring{5} when the mobile station moves new zone;

\mathring{6} when a user artificially changes a state of the mobile station;

\mathring{7} due to a compulsive instruction of a base station;

\mathring{8} when a user gives a call or receives a call; and

\mathring{9} when the base station to which the mobile station belongs changes due to a hand-off.

For example, when a vehicle starts at starting point S and travels on a link L1, a mobile terminal, which is provided in a vehicle traveling on a path illustrated in FIG. 9a, or which is carried with a driver of the vehicle, performs a first position registration according to a forced instructions (\mathring{7}) of a base station. When the vehicle travels on a link L2, because the vehicle has moved more than a predetermined distance (\mathring{4}), the mobile terminal performs a second position registration. When the vehicle travels on a link L3, because the vehicle has moved into new zone, the mobile terminal performs a third position registration. When the vehicle travels on a link L4, because the position registration condition does not occur, the mobile terminal does not transmit a position registration message. When the vehicle travels on a link L5, the mobile terminal performs a periodical position registration, that is, a fourth position registration, in accordance with a passage of a predetermined time (\mathring{3}). When the vehicle travels on a link L6, the mobile terminal performs a fifth position registration in accordance with movement (\mathring{7}) of more than a predetermined time. When the vehicle travels on a link L7, because the vehicle has moved into new zone, the mobile terminal performs a sixth position registration and then arrives at a destination E.

As a result, the mobile terminal transmits position registration messages including six traffic data to the BTS while passing through the seven links L1 to L7.

FIG. 9b illustrates an example of transmitting position registration messages including traffic data while a plurality of mobile terminals travel on peripheral road. FIG. 9b illustrates links from which traffic data is collected, when three mobile terminals (mobile terminal #1, mobile terminal #2, and mobile terminal #3) transmit the traffic data while traveling on the links.

FIG. 9c illustrates traffic data by road links, which can be obtained from position registration messages received at BTS #1 area, and FIG. 9d illustrates traffic data by road links, which can be obtained from position registration messages, received at BTS #2 area.

The BSC-based traffic server 200 synthesizes the traffic data by road links transmitted from BTSs within a control of a BSC, as illustrated in FIG. 9c and FIG. 9d, and then can obtain regional traffic information as illustrated in FIG. 9e. As described above, regional traffic information constructed according to the BSC-based traffic server 200 is converted into national traffic information by the central traffic server 100.

In the method and apparatus of the present invention for collecting traffic data in real time, as described above, messages, such as position registration messages, transmitted/received when a mobile terminal, which is in an existing mobile communication system, registers its position, can be utilized without a separate apparatus. Therefore, an initial investment cost and maintenance costs for collecting traffic data in real time can be minimized. Further, the present invention collects traffic data of corresponding positions from an unspecified plurality of mobile terminals cooperating with a navigation terminal, thereby collecting more accurately traffic data in real time.

While the present invention has been illustrated and described with reference to certain preferred embodiments thereof, it will be understood by those skilled in the art that various changes in form and details may be made therein without departing from the spirit and scope of the invention as defined by the appended claims.

What is claimed is:

1. A method for collecting traffic data in real time, the method comprising the steps of:
(1) generating and transmitting a position registration message including real time traffic data in a mobile terminal having received the real time traffic data from a navigation terminal,;
(2) managing regional traffic information within a predetermined area, and receiving the position registration message in a regional traffic server; and
(3) extracting traffic data from the position registration message in the regional traffic server, and storing the extracted traffic data in a regional traffic information management database.

2. The method as claimed in claim 1, further comprising transmitting the extracted traffic data to a central traffic server for synthetically managing national traffic data.

3. The method as claimed in claim 1, wherein, in step (1), the real time traffic data is added to a surplus area of the position registration message set in advance.

4. The method as claimed in claim 3, wherein the real time traffic data includes at least one of moving direction data, present position data, and moving speed data of the mobile terminal.

5. The method as claimed in claim 1, wherein, in step (2), the regional traffic server receives the position registration message from a BSC in an area to which the mobile terminal belongs.

6. A mobile terminal for transmitting traffic data in real time, the mobile terminal comprising:
a navigation terminal interface unit for receiving real time traffic data from a navigation terminal, which is installed on a mobile body and reads traveling information of the mobile body;
a mobile phone function processing unit for controlling mobile phone functions of the mobile terminal, and transmitting a position registration message to a BSC after determining whether a position of the mobile terminal is registered; and
a format processing unit for receiving the traffic data from the navigation terminal interface unit, temporarily storing it, generating the position registration message including the stored traffic data when a position registration message transmission is determined by the mobile phone function processing unit, and transmitting the generated position registration message to the mobile phone function processing unit.

7. The mobile terminal as claimed in claim 6, wherein the format processing unit adds the traffic data including at least one of moving direction data, present position data, and a moving speed to a surplus area of the position registration message, and then generates the position registration message including the traffic data.

8. The mobile terminal as claimed in claim 6, wherein the mobile phone function processing unit transmits the position registration message including the traffic data, which is transmitted from the format processing unit, to the BSC.

9. A regional traffic information management apparatus comprising:
a position registration message analyzing unit for receiving a position registration message from a BSC, analyzing the position registration message, and then determining whether traffic data has been included in the position registration message;
a traffic data extraction unit for extracting the traffic data from the position registration message when the traffic data has been included in the position registration message;
a traffic data decoding unit for decoding the traffic data extracted by the traffic data extraction unit; and
a regional traffic information storage unit for storing the traffic data decoded by the traffic data decoding unit as regional traffic information.

10. The regional traffic information management apparatus as claimed in claim 9, further comprising a traffic data transmission unit for transmitting at least one of a present position, a moving direction, and a moving speed of the mobile terminal decoded by the traffic data decoding unit to a central traffic information management apparatus, which synthetically manages national traffic data.

11. The regional traffic information management apparatus as claimed in claim 9, wherein the traffic data is at least one of a present position, a moving direction, and a moving speed of the mobile terminal that has transmitted the position registration message.

12. The regional traffic information management apparatus as claimed in claim 9, wherein the traffic data is classified into moving speeds and moving directions according to links, and then stored in the regional traffic information storage unit.

13. The regional traffic information management apparatus as claimed in claim 9, wherein generation time of the traffic data is managed, and traffic data that has passed a predetermined effective time is discarded in the regional traffic information storage unit.
